(19) United States
(12) Patent Application Publication
(10) Pub. No.: US 2021/0334716 A1
(43) Pub. Date: Oct. 28, 2021

(54) INFORMATION PROCESSING DEVICE AND PROGRAM

(71) Applicant: MITSUI & CO., LTD., Tokyo (JP)

(72) Inventor: Kimitsura MATSUI, Tokyo (JP)

(21) Appl. No.: 17/281,064

(22) PCT Filed: Sep. 27, 2019
(86) PCT No.: PCT/JP2019/038113

§ 371 Date: Mar. 29, 2021

(30) Foreign Application Priority Data
Sep. 27, 2018 (JP) 2018-182838

(51) Int. Cl. G06Q 10/06

(52) U.S. Cl. CPC G06Q 10/0637; G06Q 50/08

(57) ABSTRACT

The problem addressed by the present invention is to enable the presentation of more suitable information to each of construction companies, construction equipment information providers, and oil providers. A computation unit acquires, from an integrated database construction company information acquired by a construction company information acquisition unit, construction equipment information provider information acquired by a construction equipment information provider information acquisition and oil provider information acquired by an oil provider information acquisition unit, and executes the necessary computation. On the basis of the construction company information, the construction equipment information provider information, and the oil provider information, a Web screen generation unit generates information suitable for presentation to the construction companies, construction equipment information providers, and oil providers, and presents that information to the construction companies, construction equipment information providers, and oil providers. Thus, the aforementioned problem is solved.

### TECHNICAL FIELD

The present invention relates to an information processing device and program.

### BACKGROUND ART

Typically, fuel such as petroleum oil is required in every aspect of daily life, and efficient fueling is one of extremely important issues for sustaining a modern Japanese society. Meanwhile, the number of oil providing companies forced out of business have increased because these companies cannot respond to liberalization of fuel imports due to, e.g., repeal or amendment of relevant laws, a demand for repair of fueling facilities (e.g., an underground tank), reduction in fuel consumption of construction equipment, aging of a manager, etc. In such a situation, technologies for efficient fueling have been proposed. For example, Patent Document 1 describes that a fueling amount is predicted upon delivery so that fueling including delivery can be efficiently performed.

Patent Document 1: Japanese Unexamined Patent Application, Publication No. H11-208794

### DISCLOSURE OF THE INVENTION

### Problems to be Solved by the Invention

However, the typical technologies including the technology described in Patent Document 1 above are those predicting the fueling amount based mainly on a relationship between a fueling applicant requesting fueling and an oil provider performing fueling. For this reason, the accuracy of such a prediction is not always sufficient.

The present invention has been made in view of such a situation, and an object of the present invention is to provide a technique of providing information useful for supporting business of each of a construction company, a construction equipment information providing company, and an oil providing company to each of the construction company, the construction equipment information providing company, and the oil providing company.

### Means for Solving the Problems

For achieving the above-described object, an information processing device according to one embodiment of the present invention is an information processing device for providing information to each of
a first information processing terminal managed by a construction company,
a second information processing terminal managed by a construction equipment information providing company, and
a third information processing terminal managed by an oil providing company.

The information processing device includes
a constructor information acquisition section that acquires, as constructor information, various types of information regarding the construction company from the first information processing terminal,

a construction equipment information provider information acquisition section that acquires, as construction equipment information provider information, various types of information regarding the construction equipment information providing company from the second information processing terminal,

an oil provider information acquisition section that acquires, as oil provider information, various types of information regarding the oil providing company from the third information processing terminal, and

a providing section that generates suitable information to be provided to each of the construction company, the construction equipment information providing company, and the oil providing company based on the constructor information, the construction equipment information provider information, and the oil provider information and provides the suitable information to the construction company, the construction equipment information providing company, and the oil providing company.

### Effects of the Invention

According to the present invention, the technique of providing the information useful for supporting the business of each of the construction company, the construction equipment information providing company, and the oil providing company to each of the construction company, the construction equipment information providing company, and the oil providing company can be provided.

### BRIEF DESCRIPTION OF THE DRAWINGS

FIG. 1 is a diagram showing an outline of a present service targeted for application of an information processing system including a server according to one embodiment of an information processing device of the present invention;

FIG. 2 is a block diagram showing the configuration of the information processing system including the server according to one embodiment of the information processing device of the present invention;

FIG. 3 is a block diagram showing a hardware configuration of the server of the information processing system of FIG. 2;

FIG. 4 is a functional block diagram showing one example of a functional configuration of the server of FIG. 3;

FIG. 5 is a flowchart describing a flow of fueling efficiency optimization processing executed by the server of FIG. 4;

FIG. 6 is a business flowchart showing a specific example of information inputted to the server of FIG. 4 and information outputted from the server of FIG. 4;

FIG. 7 is a view showing one example of functions implemented on the server of FIG. 4;

FIG. 8 is a view showing one example of an interface provided to, e.g., a constructor of FIG. 1;

FIG. 9 is a state transition view showing one example of transition of a screen provided to, e.g., the constructor of FIG. 1;

FIG. 10 is a view showing one example of an image, which may be outputted to a display unit of a constructor terminal of FIG. 2, regarding a report by machine;

FIG. 11 is a view showing one example of an image, which may be outputted to the display unit of a constructor terminal of FIG. 2, regarding a fuel demand prediction status list;

FIG. 12 is a view showing one example of a screen, which may be outputted to an oil provider terminal of FIG. 2, indicating information regarding a fueling plan;

FIG. 13 is a view showing one example of an image, which may be outputted to the oil provider terminal of FIG. 2, regarding a map indication;

FIG. 14A is a diagram showing a specific example of a fueling vehicle delivery route which may be outputted to the oil provider terminal of FIG. 2;

FIG. 14B is a diagram showing a specific example of the fueling vehicle delivery route which may be outputted to the oil provider terminal of FIG. 2;

FIG. 15A is an image showing typical overlapping tasks;

FIG. 15B is an image showing that the typical overlapping tasks are eliminated by application of the present service; and

FIG. 16 is a flowchart showing a relationship between the constructor and an oil provider receiving the present service.

### PREFERRED MODE FOR CARRYING OUT THE INVENTION

Hereinafter, one embodiment of the present invention will be described using the drawings.

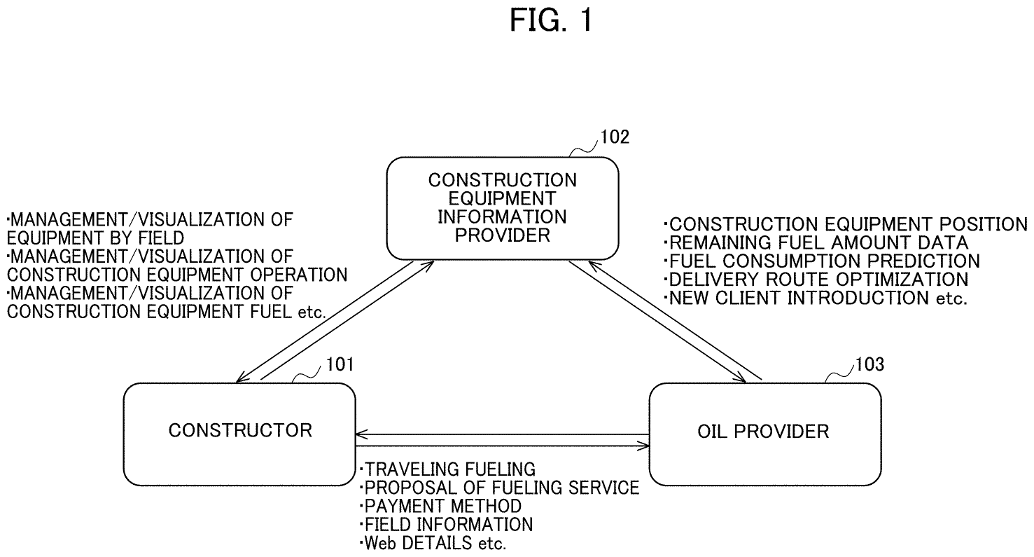

FIG. 1 is a diagram describing a relationship among a constructor, a construction equipment information provider, and an oil provider associated with a service (hereinafter referred to as a “present service”) targeted for application of an information processing system including a server according to one embodiment of an information processing device of the present invention.

The constructor 101 described herein is one example of a construction company actually performing, e.g., construction work or management in a construction work field (hereinafter referred to as a “construction field”). Specifically, the constructor 101 includes, for example, a construction field agent, a prime contractor, and a construction field representative managing a construction machine (hereinafter referred to as “construction equipment”) and a business institution actually performing construction work in, e.g., the construction field.

The construction equipment information provider 102 is one example of a company owning/manufacturing the construction equipment used in, e.g., the construction field. Specifically, the construction equipment information provider 102 includes, for example, a rental company renting the construction equipment, a manufacturing company manufacturing the construction equipment, and a company providing information regarding the construction equipment.

The oil provider 103 is one example of an oil providing company fueling the construction equipment used in, e.g., the construction field. Specifically, the oil provider 103 includes, for example, a fuel provider fueling, e.g., the construction equipment.

The example of FIG. 1 shows benefits which can be received by the constructor 101, the construction equipment information provider 102, and the oil provider 103, for the present service. That is, the present service is provided to the constructor 101 so that regardless of a construction equipment manufacturer (a construction equipment maker), multi-maker construction equipment operation information etc. can be compared and viewed using a single platform. That is, application to the present service is taken as agreement with acquisition, sharing, and utilization of equipment data, and therefore, all pieces of multi-maker construction equipment data can be collected single-handedly. Moreover, management is facilitated due to visualization of information on construction equipment fuel, and an annual fuel consumption amount etc. are easily grasped, for example. Thus, regular traveling fueling or AdBlue (an aqueous urea solution) (a registered trademark) supply is allowed. As a result, the constructor 101 can receive stable fueling.

The constructor 101 inputs the address of the construction field when applying to the present service. In this manner, e.g., an image representing a pin can be displayed on a map displayed on a screen of a later-described constructor terminal 2. In this case, a mismatch between the address of the construction field and an actual field might be caused. In this case, the constructor 101 moves the pin on the map so that the position of the pin can be corrected to the center point of the actual field. Then, e.g., a radius of several hundred meters to one kilometer about the corrected pin position is defined as the construction field, and information on the construction equipment present within such an area is collected/visualized (displayed). A visualization period can be set according to a present service application period. The present service is provided to the construction equipment information provider 102 so that information on the constructor requiring new construction equipment can be obtained, for example. Thus, the construction equipment information provider 102 can receive services such as introduction of a new customer candidate and display of information on operation of equipment owned by the construction equipment information provider 102 itself. The present service is provided to the oil provider 103 so that information such as a current construction equipment position, remaining fuel amount data, and fuel consumption prediction can be obtained. Thus, the oil provider 103 easily manages, e.g., a remaining fuel amount, and therefore, fueling of the construction equipment in an optimal traveling fueling path (hereinafter referred to as a “delivery route”) is allowed. Optimization of the delivery route is, for example, performed using the following technique. That is, the delivery route is optimized using, e.g., (1) the technique of providing a predetermined threshold for the remaining fuel amount to prioritize a construction field where construction equipment whose remaining fuel amount is likely to fall below the threshold is present as a construction field with a high degree of urgency of fueling, (2) the technique of regarding construction equipment for which update of a sensing result of a sensor that senses a remaining oil amount of the construction equipment is stopped as construction equipment in which a sensor abnormality is likely to occur and to regard a construction field where such construction equipment is present as a construction field with a high degree of urgency of fueling, (3) a technique following a fueling date and time desired by a customer (e.g., the constructor 101) (e.g., the construction equipment needs to be filled up with fuel and be returned to the construction equipment information provider 102 at a particular date and time), (4) a technique following a fueling frequency desired by a customer (e.g., the constructor 101) (e.g., the customer desires fueling at least once every two days), or (5) the technique of prioritizing a construction field with a large estimated fuelable amount as a construction field with a high degree of urgency of fueling. The delivery route may be automatically optimized based on various types of collected data, but may be regenerated (recalculated) according to various conditions etc. (e.g., a sudden traffic jam) in the real world. The oil providing company may add, by manual operation, a destination construction field to the automatically-generated optimal delivery route based on the condition such as (2), (3), or (4) described above. In this case, the delivery route may be regenerated (recalculated) based on the manual operation by the oil providing company. Summarizing the description above, the present service is an information providing service for implementing efficient construction field fueling operation for each of the constructor 101, the construction equipment information provider 102, and the oil provider 103 by an information and communication technology (ICT).

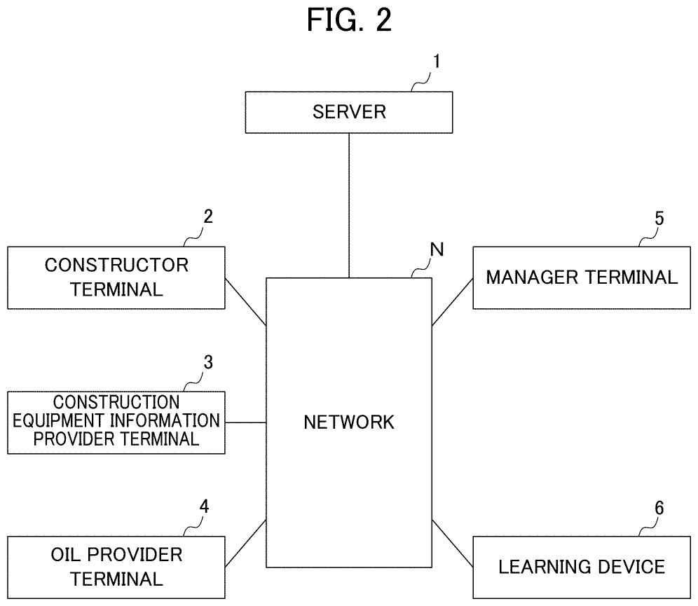

FIG. 2 is a block diagram showing the configuration of the information processing system including the server according to one embodiment of the information processing device of the present invention. The information processing system of FIG. 2 includes the server 1 managed by a provider (hereinafter referred to as a “service provider”) of the present service, the constructor terminal 2 used by each representative of the constructor 101, a construction equipment information provider terminal 3 used by each representative of the construction equipment information provider 102, an oil provider terminal 4 used by each representative of the oil provider 103, a manager terminal 5 managed by a representative of the service provider, and a learning device 6. The server 1, the constructor terminal 2, the construction equipment information provider terminal 3, the oil provider terminal 4, the manager terminal 5, and the learning device 6 are connected to each other via a predetermined network N such as the Internet.

Each representative of the constructor 101, each representative of the construction equipment information provider 102, and each representative of the oil provider 103 can utilize the present service by means of the constructor terminal 2, the construction equipment information provider terminal 3, and the oil provider terminal 4 on which application software (hereinafter referred to as a “dedicated application”) dedicated to a user of the present service has been installed. Moreover, each representative of the constructor 101, each representative of the construction equipment information provider 102, and each representative of the oil provider 103 can also utilize the present service via a website (hereinafter referred to as a “dedicated site”) dedicated to the user of the present service, the dedicated site being displayed by browser functions of the constructor terminal 2, the construction equipment information provider terminal 3, and the oil provider terminal 4. Note that unless otherwise provided, an expression “each representative of the constructor 101 operates the constructor terminal 2” may hereinafter have any of the following meanings. That is, such an expression may mean that each representative of the constructor 101 starts the dedicated application installed on the constructor terminal 2 to perform various types of operation or utilizes the present service via the dedicated site displayed by the browser function of the constructor terminal 2. An expression “each representative of the construction equipment information provider 102 operates the construction equipment information provider terminal 3” may have any of the following meanings. That is, such an expression may mean that each representative of the construction equipment information provider 102 starts the dedicated application installed on the construction equipment information provider terminal 3 to perform various types of operation or utilizes the present service via the dedicated site displayed by the browser function of the construction equipment information provider terminal 3. An expression “each representative of the oil provider 103 operates the oil provider terminal 4” may have any of the following meanings. That is, such an expression may mean that each representative of the oil provider 103 starts the dedicated application installed on the oil provider terminal 4 to perform various types of operation or utilizes the present service via the dedicated site displayed by the browser function of the oil provider terminal 4.

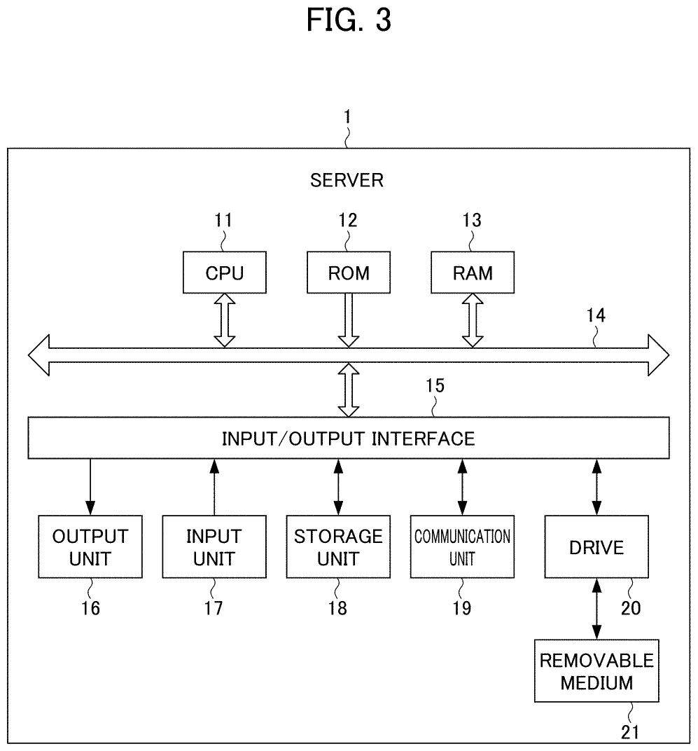

FIG. 3 is a block diagram showing a hardware configuration of the server of the information processing system of FIG. 2. The server 1 includes a central processing unit (CPU) 11, a read only memory (ROM) 12, a random access memory (RAM) 13, a bus 14, an input/output interface 15, an output unit 16, an input unit 17, a storage unit 18, a communication unit 19, and a drive 20.

The CPU 11 executes various types of processing according to various programs recorded in the ROM 12 or various programs loaded into the RAM 13 from the storage unit 18. The RAM 13 also stores, e.g., data necessary for executing various types of processing by the CPU 11, as necessary.

The CPU 11, the ROM 12, and the RAM 13 are connected to each other via the bus 14. Moreover, the input/output interface 15 is also connected to the bus 14. The output unit 16, the input unit 17, the storage unit 18, the communication unit 19, and the drive 20 are connected to the input/output interface 15.

The output unit 16 includes, e.g., various liquid crystal displays, and outputs various types of information. The input unit 17 includes, e.g., various types of hardware, and inputs various types of information.

The storage unit 18 includes, e.g., a hard disk and a dynamic random access memory (DRAM), and stores various types of data. The communication unit 19 controls communication with other devices (e.g., the constructor terminal 2, the construction equipment information provider terminal 3, and the oil provider terminal 4 of FIG. 2) via the network N including the Internet.

The drive 20 is provided as necessary. A removable medium 21 including, e.g., a magnetic disk, an optical disk, a magneto-optical disk, or a semiconductor memory is attached to the drive 20, as necessary. A program read from the removable medium 21 by the drive 20 is installed on the storage unit 18, as necessary. The removable medium 21 can also store, as in the storage unit 18, various types of data stored in the storage unit 18.

Note that the hardware configuration of the server 1 is not necessarily the above-described configuration, and for example, may be an information processing terminal having a not-shown touch panel. The configurations of the constructor terminal 2, the construction equipment information provider terminal 3, the oil provider terminal 4, the manager terminal 5, and the learning device 6 are basically similar to the hardware configuration of the server 1, and therefore, description thereof will be omitted herein.

A series of processing as described later can be executed by cooperation between various types of hardware and various types of software in the server 1 of FIG. 3, the constructor terminal 2, the construction equipment information provider terminal 3, the oil provider terminal 4, the manager terminal 5, and the learning device 6.

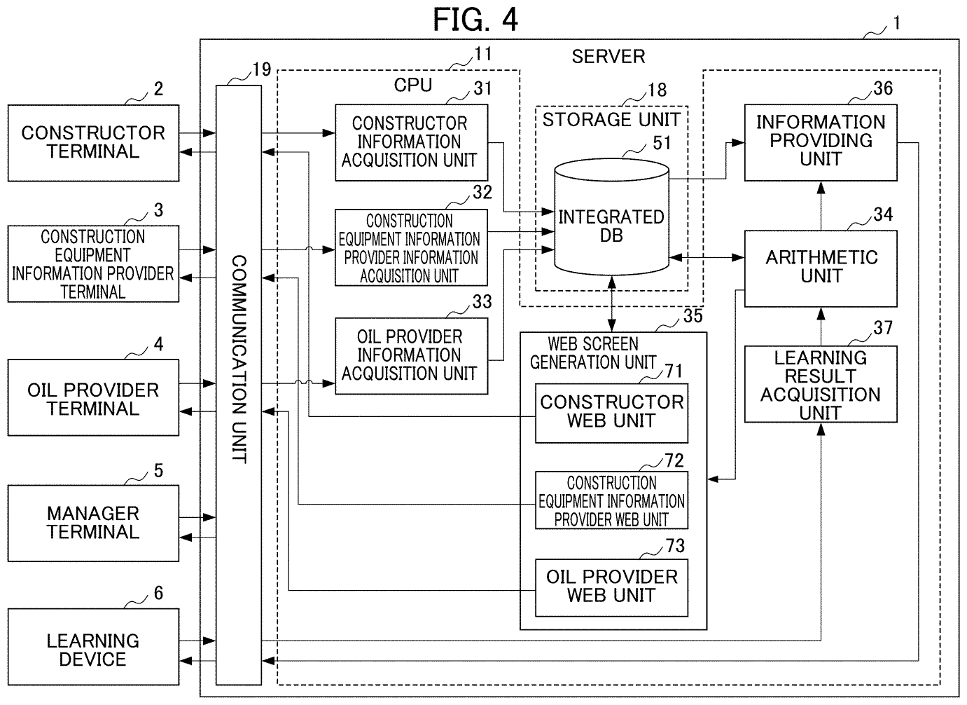

FIG. 4 is a functional block diagram showing one example of a functional configuration of the server of FIG. 3.

A constructor information acquisition unit 31, a construction equipment information provider information acquisition unit 32, an oil provider information acquisition unit 33, an arithmetic unit 34, a WEB screen generation unit 35, an information providing unit 36, and a learning result acquisition unit 37 function in the CPU 11 of the server 1. A constructor WEB unit 71, a construction equipment information provider WEB unit 72, and an oil provider WEB unit 73 are provided in the WEB screen generation unit 35. An integrated DB 51 is provided in a partial area of the storage unit 18 of the server 1.

The constructor information acquisition unit 31 acquires, as constructor information, various types of information regarding, e.g., the construction field managed by the constructor 101 from the constructor terminal 2. That is, the constructor information acquisition unit 31 acquires, as the constructor information, various types of information regarding, e.g., a construction field managed by each of a plurality of constructors 101 via the communication unit 19 from each of constructor terminals 2 of the constructors 101, and stores such information in the integrated DB 51.

The construction equipment information provider information acquisition unit 32 acquires, as construction equipment information provider information, various types of information regarding the construction equipment owned by the construction equipment information provider 102 from the construction equipment information provider terminal 3. That is, the construction equipment information provider information acquisition unit 32 acquires, as the construction equipment information provider information, information regarding construction equipment owned by each of a plurality of construction equipment information providers 102 via the communication unit 19 from each of construction equipment information provider terminals 3 of the construction equipment information providers 102, and stores such information in the integrated DB 51.

The oil provider information acquisition unit 33 acquires, as oil provider information, various types of information regarding, e.g., fuel managed by the oil provider 103 and a delivery status from the oil provider terminal 4. That is, the oil provider information acquisition unit 33 acquires, as the oil provider information, various types of information regarding fuel managed by each of a plurality of oil providers 103 via the communication unit 19 from each of oil provider terminals 4 of the oil providers 103, and stores the information in the integrated DB 51.

The arithmetic unit 34 acquires each of the constructor information acquired by the constructor information acquisition unit 31, the construction equipment information provider information acquired by the construction equipment information provider information acquisition unit 32, and the oil provider information acquired by the oil provider information acquisition unit 33 from the integrated DB 51, thereby executing necessary arithmetic processing. That is, although details will be described later, in a case where a more appropriate WEB screen is generated for each of the constructor 101, the construction equipment information provider 102, and the oil provider 103 in the WEB screen generation unit 35, it is not always appropriate that the WEB screen generation unit 35 directly utilizes various types of information stored in the integrated DB 51. For this reason, the arithmetic unit 34 performs, for example, arithmetic processing utilizing a statistical technique or a technique regarding mechanical learning, thereby generating information which may be useful for supporting business of each of the constructor 101, the construction equipment information provider 102, and the oil provider 103.

The WEB screen generation unit 35 generates, based on the constructor information, the construction equipment information provider information, and the oil provider information, suitable information to be provided to each of the constructor 101, the construction equipment information provider 102, and the oil provider 103, thereby providing the generated information to each of the constructor 101, the construction equipment information provider 102, and the oil provider 103. That is, the WEB screen generation unit 35 generates, based on the constructor information, the construction equipment information provider information, and the oil provider information stored in the integrated DB 51 and a result obtained by the arithmetic processing in the arithmetic unit 34, the WEB screen to be provided to each of the constructor 101, the construction equipment information provider 102, and the oil provider 103, thereby providing such a WEB screen to each of the constructor terminal 2, the construction equipment information provider terminal 3, and the oil provider terminal 4.

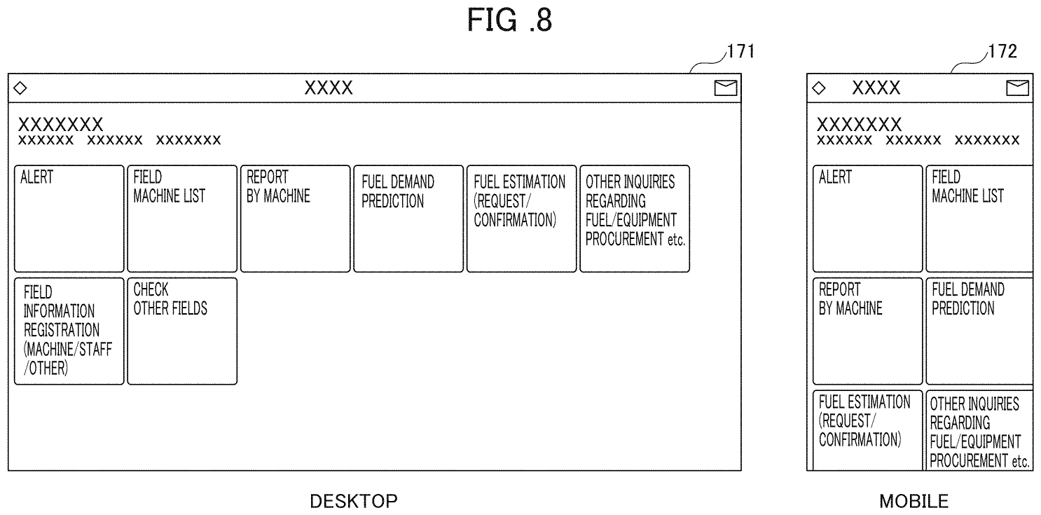

Specifically, the constructor WEB unit 71 generates the WEB screen to be provided to the constructor 101 based on the constructor information, the construction equipment information provider information, and the oil provider information stored in the integrated DB 51 and the result obtained by the arithmetic processing in the arithmetic unit 34, thereby providing such a WEB screen to the constructor terminal 2. Note that one example of the WEB screen generated herein will be described later with reference to, e.g., FIG. 8.

The construction equipment information provider WEB unit 72 generates the WEB screen to be provided to the construction equipment information provider 102 based on the constructor information, the construction equipment information provider information, and the oil provider information stored in the integrated DB 51 and the result obtained by the arithmetic processing in the arithmetic unit 34, thereby providing such a WEB screen to the construction equipment information provider terminal 3.

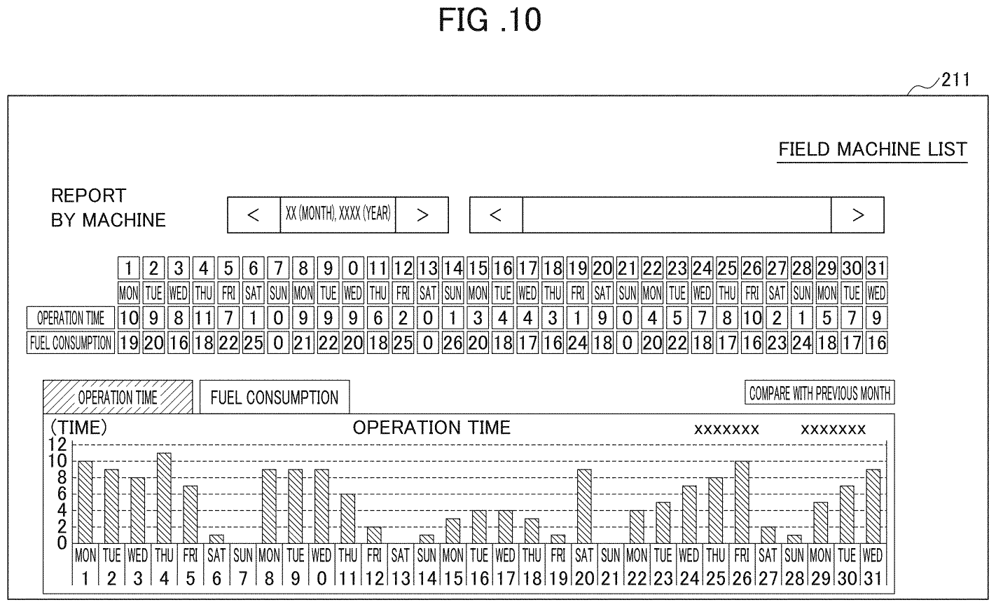

The oil provider WEB unit 73 generates the WEB screen to be provided to the oil provider 103 based on the constructor information, the construction equipment information provider information, and the oil provider information stored in the integrated DB 51 and the result obtained by the arithmetic processing in the arithmetic unit 34, thereby providing such a WEB screen to the oil provider terminal 4. Note that one example of the WEB screen generated herein will be described later with reference to, e.g., FIG. 10.

The information providing unit 36 provides the learning device 6 with the constructor information, the construction equipment information provider information, and the oil provider information stored in the integrated DB 51 and information such as the result obtained by the arithmetic processing in the arithmetic unit 34. That is, the information providing unit 36 transmits the constructor information, the construction equipment information provider information, and the oil provider information stored in the integrated DB 51 and various types of information used for leaning, such as the result obtained by the arithmetic processing in the arithmetic unit 34, to the learning device 6 via the communication unit 19. The learning device 6 executes learning by means of, e.g., various types of information transmitted from the server 1. Note that the learning device 6 can perform learning by freely utilizing not only an existing mechanical learning technique such as deep learning or clustering but also various algorithms not classified as mechanical learning techniques, for example. The learning device 6 transmits a learning result (e.g., a training model obtained as a learning result, and hereinafter referred to as a “learning result”) to the server 1.

The learning result acquisition unit 37 acquires the learning result transmitted from the learning device 6. Note that the learning result acquired by the learning result acquisition unit 37 may be, for example, utilized for the arithmetic processing in the arithmetic unit 34, as necessary.

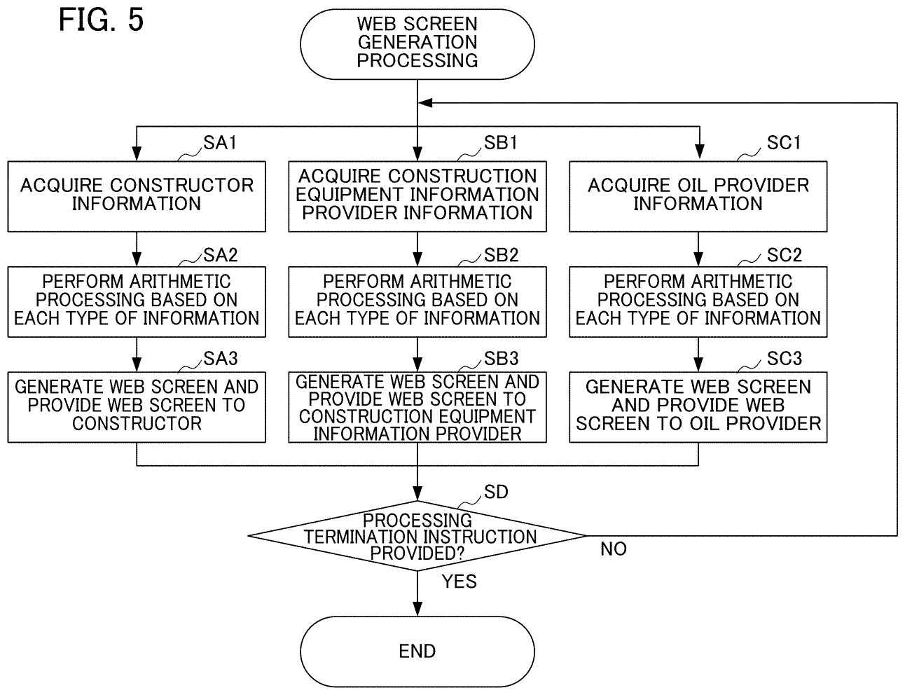

FIG. 5 is a flowchart describing the flow of fueling efficiency optimization processing by the server of FIG. 4.

At a step SA1, for each of the plurality of constructors 101, the constructor information acquisition unit 31 acquires, as the constructor information, various types of information regarding, e.g., a construction field managed by each constructor 101 from each constructor terminal 2.

At a step SA2, the arithmetic unit 34 acquires the constructor information acquired by the constructor information acquisition unit 31 from the integrated DB 51, thereby executing the necessary arithmetic processing.

At a step SA3, the constructor WEB unit 71 generates the WEB screen to be provided to the constructor 101 based on the constructor information, the construction equipment information provider information, and the oil provider information stored in the integrated DB 51 and the result obtained by the arithmetic processing in the arithmetic unit 34, thereby providing such information to the constructor terminal 2.

At a step SB1, for each of the plurality of construction equipment information providers 102, the construction equipment information provider information acquisition unit 32 acquires, as the construction equipment information provider information, various types of information on each construction equipment information provider 102 from each construction equipment information provider terminal 3.

At a step SB2, the arithmetic unit 34 acquires the construction equipment information provider information acquired by the construction equipment information provider information acquisition unit 32 from the integrated DB 51, thereby executing the necessary arithmetic processing.

At a step SB3, the construction equipment information provider WEB unit 72 generates the WEB screen to be provided to the construction equipment information provider 102 based on the constructor information, the construction equipment information provider information, and the oil provider information stored in the integrated DB 51 and the result obtained by the arithmetic processing in the arithmetic unit 34, thereby providing such information to the construction equipment information provider terminal 3.

At a step SC1, for each of the plurality of oil providers 103, the oil provider information acquisition unit 33 acquires, as the oil provider information, various types of information on each oil provider 103 from each oil provider terminal 4 thereof.

At a step SC2, the arithmetic unit 34 acquires the oil provider information acquired by the oil provider information acquisition unit 33 from the integrated DB 51, thereby executing the necessary arithmetic processing.

At a step SC3, the oil provider WEB unit 73 generates the WEB screen to be provided to the oil provider 103 based on the constructor information, the construction equipment information provider information, and the oil provider information stored in the integrated DB 51 and the result obtained by the arithmetic processing in the arithmetic unit 34, thereby providing such information to the oil provider terminal 4.

Note that the steps SA1 to SC3 as described above are not necessarily performed in the above-described order, and the order can be changed, for example. That is, as an option, the server 1 may acquire the oil provider information before acquiring the constructor information, or these types of information may be acquired in parallel, for example.

At a step SD, the CPU 11 of the server 1 determines whether or not a processing termination instruction has been provided. The processing termination instruction as described herein is not particularly limited, but in the present embodiment, an instruction for causing the server 1 to transition to, e.g., a so-called sleep state is employed. That is, as long as the instruction for causing the server 1 to transition to, e.g., the sleep state is not provided, it is determined as NO at the step SD. Thus, the processing returns to the steps SA1 to SC1, and the subsequent processing thereof is repeated. On the other hand, when the instruction for causing the server 1 to transition to, e.g., the sleep state is provided, it is determined as YES at the step SD, and WEB screen generation processing ends.

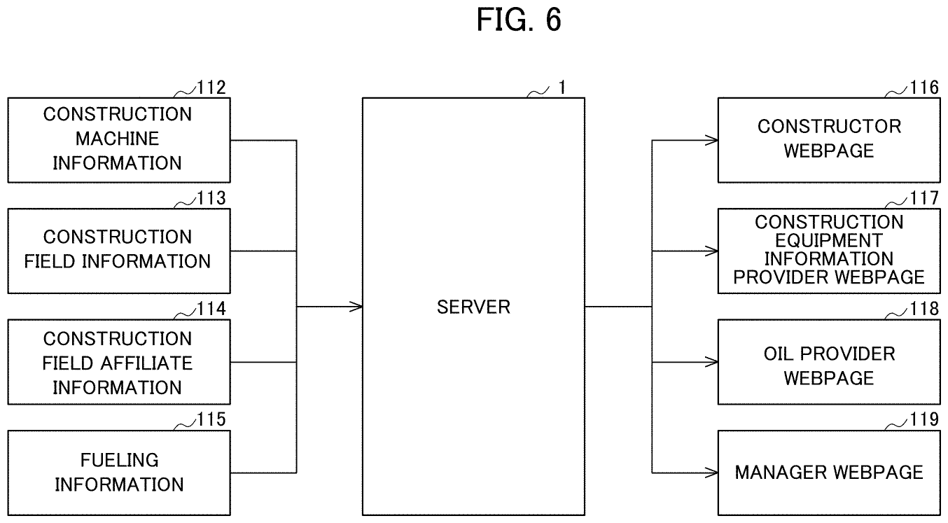

Next, specific contents of the constructor information, the construction equipment information provider information, and the oil provider information as described above will be described in detail with reference to FIG. 6. FIG. 6 is a diagram showing a specific example of information inputted to the server 1 of FIG. 4 and information outputted from the server 1 of FIG. 4. As shown in FIG. 6, construction machine information 112, construction field information 113, construction field affiliate information 114, and fueling information 115 are employed as one example of the information inputted to the server 1, for example. The construction machine information 112 is, for example, information regarding a model, a serial number, a construction equipment operation time, position information, a remaining fuel amount, and a remaining aqueous urea solution amount. Note that these types of information may be, as any of the constructor information and the construction equipment information provider information as described above, inputted from the constructor terminal 2 or the construction equipment information provider terminal 3 to the server 1. The construction field information 113 is, for example, information regarding a construction field name, a construction type, a construction period, a constructor name, and an oil provider name. Note that these types of information may be inputted from, e.g., the constructor terminal 2, the construction equipment information provider terminal 3, the oil provider terminal 4, or the manager terminal 5 to the server 1. The construction field affiliate information 114 is information on, e.g., dedicated construction work company name, location, and representative name for each of the constructor, the construction equipment information provider, and the oil provider. Needless to say, these types of information may be, as the constructor information, the construction equipment information provider information, and the oil provider information, inputted from the constructor terminal 2, the construction equipment information provider terminal 3, and the oil provider terminal 4 to the server 1. The fueling information 115 is information on, e.g., a fueling target, a fueling amount (L), a fueling date, a remaining fuel amount at a fueling facility, and an oil provider name. Note that these types of information may be, as the above-described oil provider information, mainly inputted from the oil provider terminal 4 to the server 1.

Based on the information inputted as described above, the arithmetic unit 34 of the server 1 executes various types of arithmetic processing as described above. Then, the WEB screen generation unit 35 of the server 1 generates webpages to be provided to the constructor terminal 2, the construction equipment information provider terminal 3, the oil provider terminal 4, and the manager terminal 5 based on various types of inputted information and the result obtained by the arithmetic processing in the arithmetic unit 34.

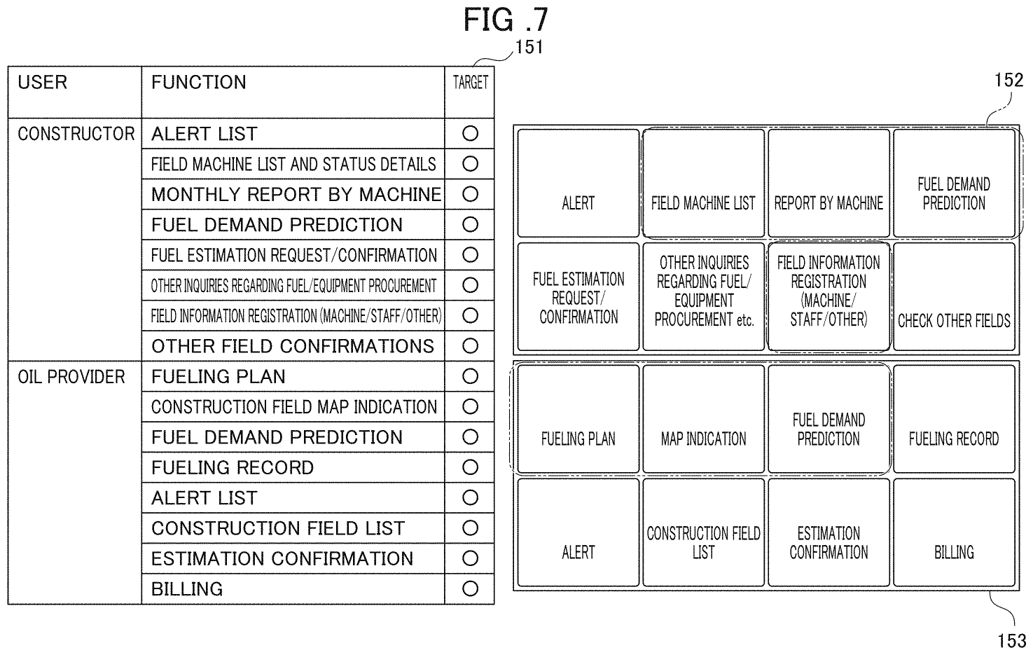

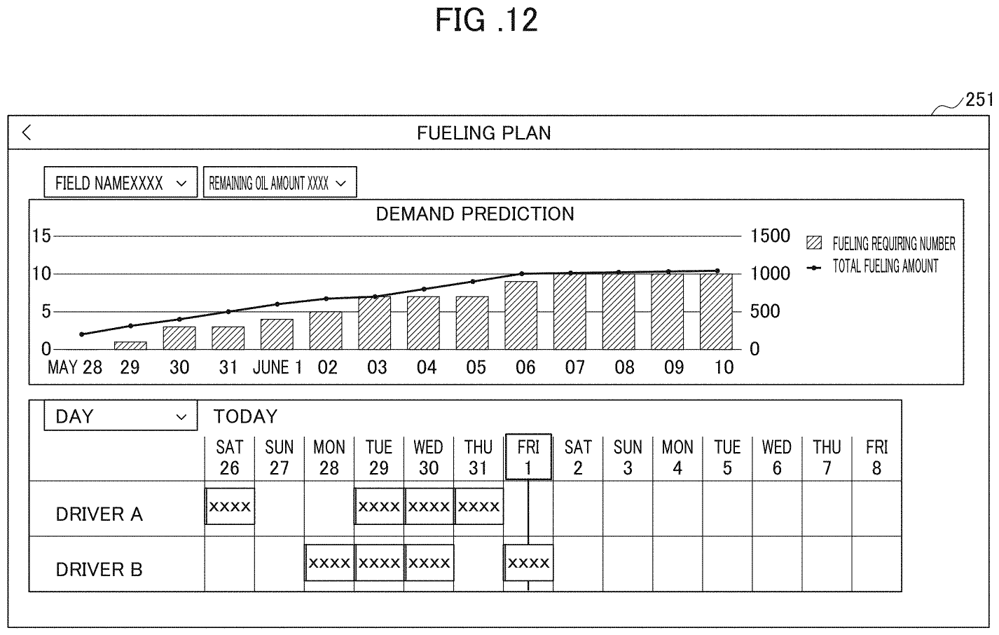

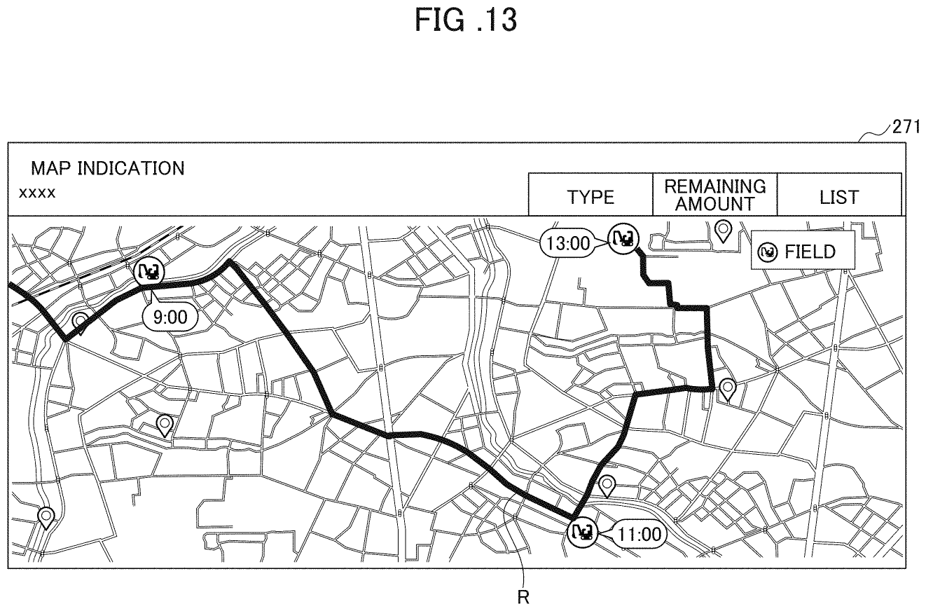

One example of information included in the webpages generated as described above include a constructor webpage 116, a construction equipment information provider webpage 117, an oil provider webpage 118, and a manager webpage 119. Note that each of these webpages may include the following contents (functions), for example. That is, the constructor webpage 116 may include, for example, functions regarding an alert, a field machine list, a report by machine, a fuel demand prediction, a fuel estimation request, a request for procuring other types of equipment, a field information registration, and other field verifications. Note that details of some of these various functions will be described later with reference to, e.g., FIGS. 7 to 11. The construction equipment information provider webpage 117 may include, for example, functions regarding an alert, a construction field list, a report by machine, a billing, a construction equipment registration, a registered information update, an estimation confirmation, and a double rental inquiry. Note that “double rental” indicates such a mechanism in which the construction equipment information provider 102 renting the construction equipment to the constructor 101 rents construction equipment which is not owned by the construction equipment information provider 102 itself from another construction equipment information provider 102 and rents such construction equipment to the constructor 101. The oil provider webpage 118 may include, for example, functions regarding an alert, a fueling plan, a map indication, a fuel demand prediction, a fueling record, a construction field list, an estimation confirmation, and a billing. Note that details of some of these various functions will be described later with reference to, e.g., FIG. 7, FIG. 12, or FIG. 13. The manager webpage 119 may include, for example, functions regarding various management screens.

Next, one example of various types of information provided to the constructor, the oil provider, etc. in the present service will be briefly described with reference to FIG. 7. FIG. 7 is a view showing one example of a screen which may be outputted from the output unit of the server of FIG. 4, and is one example of a management screen provided to the manager terminal.

In the example of FIG. 7, a table 151, a table 152, and a table 153 are employed as one example of the management screen provided to the service provider. As one example, the table 151 includes, as items thereof, each function provided to the constructor 101 and the oil provider 103 in the present service, for example. Specifically, various functions such as “ALERT FUNCTION”, “FIELD MACHINE LIST AND STATUS DETAILS”, “MONTHLY REPORT BY MACHINE”, “FUEL DEMAND PREDICTION”, “FUEL ESTIMATION REQUEST/CONFIRMATION”, “OTHER INQUIRIES REGARDING FUEL/EQUIPMENT PROCUREMENT”, “FIELD INFORMATION REGISTRATION (MACHINE/STAFF/OTHER)”, and “OTHER FIELD CONFIRMATIONS” are provided to the constructor 101, for example. For example, various functions such as “FUELING PLAN”, “CONSTRUCTION FIELD MAP INDICATION”, “FUEL DEMAND PREDICTION”, “FUELING RECORD”, “ALERT LIST”, “CONSTRUCTION FIELD LIST”, “ESTIMATION CONFIRMATION”, and “BILLING” are provided to the oil provider 103. The table 152 described herein shows one example of an interface in a case where those, which can be utilized by, e.g., the constructor 101, of various functions described above are provided to, e.g., the constructor 101. The table 153 shows one example of an interface in a case where those, which can be utilized by, e.g., the oil provider 103, of various functions described above are provided to, e.g., the oil provider 103. Note that details of the functions will be described as necessary with reference to the subsequent drawings. Similarly, FIG. 8 shows a plurality of examples of the interface in a case where the functions are provided to, e.g., the constructor 101 as described above. Note that these interface examples may be, for example, separately employed for different types of hardware such as a so-called desktop personal computer and a mobile terminal. For example, a screen 171 shows one example of the interface of the so-called desktop personal computer. A screen 172 shows one example of the interface of the mobile terminal. On any of the screen 171 and the screen 172, buttons indicated by “ALERT”, “FIELD MACHINE LIST”, “REPORT BY MACHINE”, “FUEL DEMAND PREDICTION”, “FUEL ESTIMATION (REQUEST/CONFIRMATION)”, “OTHER INQUIRIES REGARDING FUEL/EQUIPMENT PROCUREMENT”, “FIELD INFORMATION REGISTRATION (MACHINE/STAFF/OTHER)”, and “CHECK OTHER FIELDS” can be displayed.

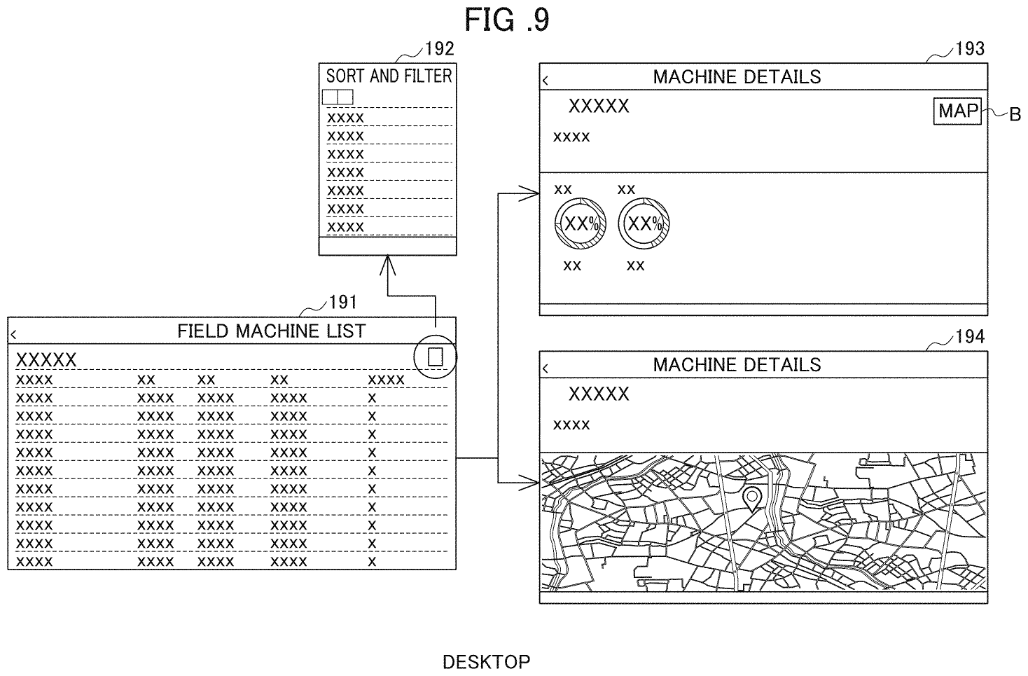

Next, regarding “FIELD MACHINE LIST” described above, the status of transition of the screen provided to, e.g., the constructor 101 will be briefly described with reference to FIG. 9. FIG. 9 is a view showing a state transition as one example of transition of the screen provided to, e.g., the constructor regarding “FIELD MACHINE LIST” described above.

In FIG. 9 described herein, transition states 191 to 194 show the state of each image, and state transition from the state of one image to the state of another image is made when a predetermined condition (hereinafter referred to as a “state transition condition”) is satisfied.

In the present embodiment, the transition state 191 showing “FIELD MACHINE LIST” is a basic state as shown in FIG. 9, and, when e.g., the representative (hereinafter referred to as a “user” in FIG. 9) of the constructor 101 provides a predetermined operation instruction, the basic state transitions to the state of another image. For example, when the user clicks a first button displayed on the upper right side in the transition state 191, a first state transition condition is satisfied. Then, the state transitions to the transition state 192. In the transition state 192, the user utilizes sort (rearranging) and filter functions so that a machine that the user desires to view can be preferentially displayed among machines displayed in the field machine list.

For example, when the user clicks each item for the machines displayed in the field machine list in the transition state 191, a second state transition condition is satisfied. Then, the state transitions to the transition state 193. In the transition state 193, the user can check machine details, i.e., information regarding fuel for the selected construction equipment.

For example, when the user clicks a button B indicated by “MAP” in the transition state 193, a third transition condition is satisfied. Then, the state transitions to the transition state 194. In the transition state 194, the user can check machine details, i.e., a current machine location on the map. Alternatively, the user can display the list of machines operating in fields on a single map instead of one by one.

Note that the images displayed for the user are assumed as the transition states, but these images are not necessarily displayed separately and may be displayed overlapping with each other, for example. Moreover, needless to say, these images merely show one example of an image displayed for the user, and are mere examples.

Next, one example of a displayed image of “MONTHLY REPORT BY MACHINE” of various types of information displayed on each of the constructor 101 and the construction equipment information provider terminal 3 in the present service will be described with reference to FIG. 10. FIG. 10 is a view showing one example of the image regarding the report by machine that can be outputted to a display unit of the constructor terminal.

In the example of FIG. 10, predetermined construction equipment operation time and fuel consumption at XX (month), XXXX (year) are displayed daily as a table or a graph. Specifically, focusing on, e.g., items at XX (month) 1 (Monday) in FIG. 10, the operation time of the target construction equipment at XX (month) 1 (Monday) is “10 HOURS”, and the fuel consumption is “19”. Similarly, the operation time of the construction equipment at XX (month) 2 (Tuesday) is “9 HOURS”, and the fuel consumption is “20”. As described above, in the present service, information such as the operation time and the fuel consumption can be collectively provided to, e.g., the constructor in every certain period, and therefore, the construction equipment can be more easily managed. Note that a design of such a displayed image may be made regardless of a device, and may be determined for each project by, e.g., the service provider.

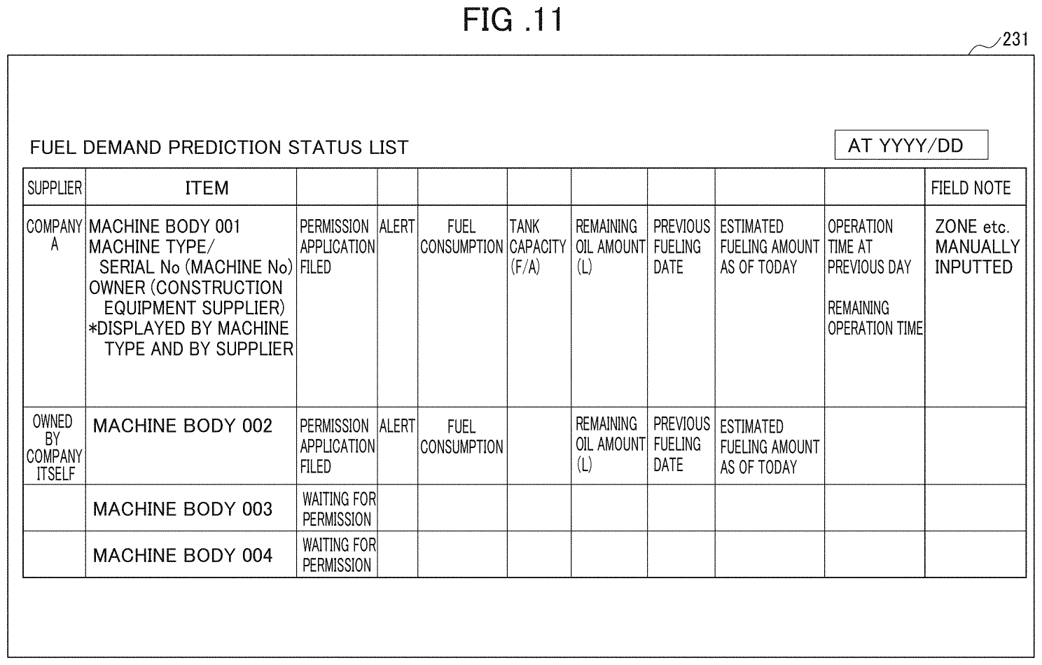

Next, one example of a displayed image of “FUEL DEMAND PREDICTION” of various types of information displayed for the constructor 101 in the present service will be described with reference to FIG. 11. FIG. 11 is a view showing one example of an image, which may be outputted to the display unit of the constructor terminal, regarding a fuel demand prediction status list.

In the example of FIG. 11, various types of information regarding the fuel demand prediction, such as information on the construction equipment itself are collectively displayed, the information on the construction equipment itself including information on a supplier, a machine number, a machine type of the construction equipment used in the field. As described above, in the present service, the fuel prediction status is provided to, e.g., the constructor 101 so that the construction equipment can be more easily managed.

In a case where, e.g., the service provider predicts the remaining oil amount in association with the above-described fuel demand prediction, such prediction can be made by the following method, for example. That is, e.g., the service provider can make prediction by a method such as (1) calculation of the remaining oil amount by, e.g., division using the latest fuel consumption, (2) application of a time-series prediction to the remaining oil amount, or (3) application of a prediction model based on a fuel consumption determinant such as a scheduled task or the operation time. Needless to say, these methods are not necessarily executed alone, and the service provider may utilize, e.g., other general methods in combination with these methods to make prediction with a higher accuracy. Alternatively, the service provider may implement, e.g., a graph comparing an actual versus forecast remaining oil amount in association with the remaining oil amount, or may display the prediction according to a progress in the field. As in the example of FIG. 10, a design of such a displayed image may be made regardless of a device, and may be determined for each project by, e.g., the service provider.

Next, one example of a displayed image of “FUELING PLAN” of various types of information displayed for the oil provider 103 in the present service will be described with reference to FIG. 12. FIG. 12 is a view showing one example of a screen indicating information, which may be outputted to the oil provider terminal, regarding the fueling plan.

On a screen 251 of FIG. 12, the information regarding the fueling plan is displayed. On an upper side of the screen 251, a fuel demand prediction in, e.g., each construction field and the number (hereinafter referred to as a “fuel requiring number”) of fueling vehicles required according to the fuel demand prediction are displayed as graphs. Note that these types of information may be, as described above, acquired as a result of the arithmetic processing executed based on the constructor 101, the construction equipment information provider 102, and the oil provider 103 in the arithmetic unit 34. On the other hand, on a lower side of FIG. 12, the latest scheduled fueling list is, on a daily basis, displayed for each driver of the fueling vehicles. That is, in the present service, the schedule of each driver can be displayed in addition to the predicted fueling demand, and can be further changed, for example. Thus, the oil provider 103 can more efficiently manage the fueling plan. As in the examples of FIGS. 10 and 11, a design of such a displayed image may be made regardless of a device, and may be determined for each project by, e.g., the service provider.

Next, one example of a displayed image of “CONSTRUCTION FIELD MAP INDICATION” of various types of information displayed for the oil provider 103 in the present service will be described with reference to FIG. 13. FIG. 13 is a view showing one example of a screen indicating information, which may be outputted to the oil provider terminal, regarding the map indication.

A screen 271 of FIG. 13 shows one example of a map on which a delivery route R and an estimated arrival time at each construction field are displayed. As described above, the delivery route R indicates the traveling fueling path optimized based on the information such as the current construction equipment position, the remaining fuel amount data, and the fuel consumption prediction so that the fueling vehicle can be efficiently fueled. In the example of the screen 271, icons indicating position information on fields where construction equipment requiring fueling is present are displayed on the map, and therefore, the specific position of the fueling vehicle is visualized. Moreover, the delivery route R of the fueling vehicle and the estimated arrival time (in the example of FIG. 13, “9:00”, “11:00”, and “13:00”) of the fueling vehicle at each construction field are displayed on the map. With this configuration, the delivery route R for efficient fueling and the estimated arrival time at each construction field can be grasped at first glance. Note that the service provider may utilize, upon generation of these images, e.g., any type of software capable of displaying a map etc. As in the examples of FIGS. 10 to 12, a design of such a displayed image may be made regardless of a device, and may be determined for each project by, e.g., the service provider.

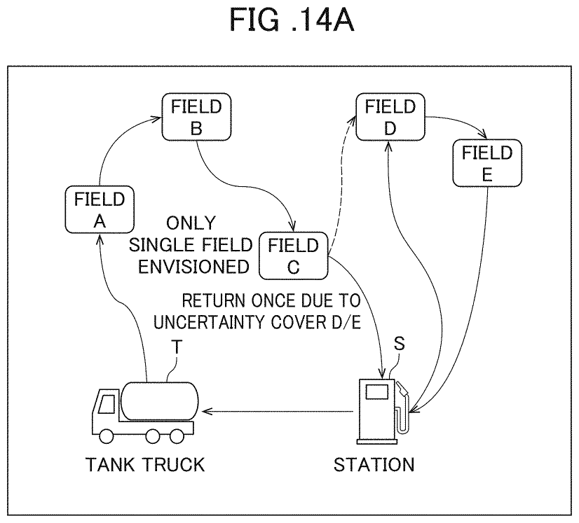

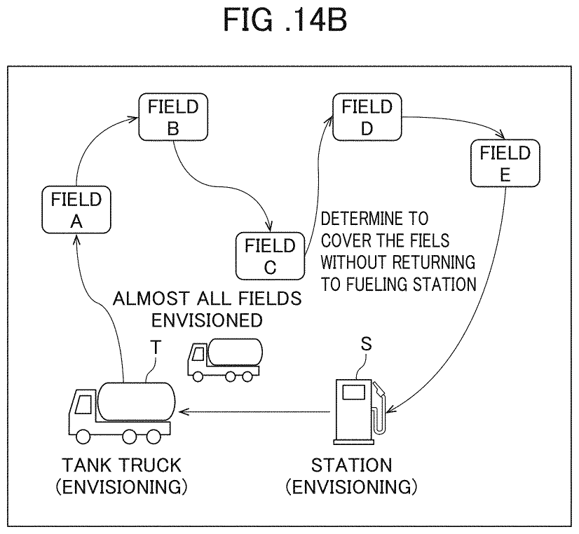

Next, the fueling vehicle delivery route which may be outputted to the oil provider terminal 4 will be described with reference to FIG. 14.

Typically, fueling of construction equipment in a construction field has been performed based on an individual request for an oil provider from a constructor managing the construction equipment. For this reason, the timing of fueling of construction equipment naturally depends on a decision of each representative of the constructor, and due to, e.g., representative's uncertainty over fuel shortage, the fueling request has often been made at timing with excessive margin in advance. For example, there have been many situations where although the remaining fuel amount is about 80% of a full amount, fueling is performed for the construction equipment at least once every two days.

As described above, fueling has been inefficiently performed for the construction equipment in the construction field. However, the remaining fuel amount of each type of construction equipment is sequentially checked (hereinafter referred to as “envisioned”) even from a remote location so that the number of times of fueling can be reduced. Considering the capacity of the fueling vehicle and the delivery route of the fueling vehicle, the number of times of fueling can be optimized.

FIGS. 14A and 14B are diagrams showing a specific example of the fueling vehicle delivery route which may be outputted to the oil provider terminal.

In FIGS. 14A and 14B, a tank truck T as a specific example of the fueling vehicle, a fueling facility S (hereinafter referred to as a “station S”) of the oil provider fueling a tank of the tank truck T, and fields A to E indicating construction fields on the delivery route are shown. The tank truck T performs fueling in the order of the fields A to E along the delivery route after the tank of the tank truck T itself has been filled with fuel at the station S.

FIG. 14A shows, as an example, a case where the remaining fuel amount of the construction equipment located in the field C has been envisioned. In this case, a driver of the tank truck T does not know the remaining fuel amounts in the fields D, E upon completion of fueling in the fields A to C. For this reason, the driver of the tank truck T returns to the station S just in case, and performs fueling in the fields D, E after the tank of the tank truck T has been refilled with fuel. Note that even in a case where only some of the construction fields have been envisioned as shown in FIG. 14A, it can be expected that the number of times of fueling is reduced by about 40% to 50% on average as compared to a case where no envisioning has been performed at all.

FIG. 14B shows an example of a case where the remaining fuel amounts of the station S and the tank truck T and the remaining fuel amount of the construction equipment located in each of the fields A, C to E have been envisioned. In this case, the remaining fuel amounts in, e.g., almost all fields can be sequentially checked from a remote location. Thus, the driver of the tank truck T can grasp the remaining fuel amounts in the fields D, E upon completion of fueling in the fields A to C. Thus, based on a determination that the remaining load capacity of the tank truck T at this point can also cover the fields D, E, fueling can be performed in the fields D, E without the need to return to the station S. As shown in FIG. 14B, efficiency optimization of the delivery route of the tank truck T and reduction in the number of times of fueling can be achieved by envisioning the remaining fuel amounts of the station S and the tank truck T and the remaining fuel amount of the construction equipment located in each of many fields.

A specific technique for envisioning the remaining fuel amount of the construction equipment located in each construction field is not particularly limited, and a wide variety of techniques can be used. Specifically, the remaining fuel amount of the construction equipment located in each construction field can be envisioned based on data obtained from a database owned by the constructor managing the construction equipment, sensing data obtained from various sensors mounted on the construction equipment, data obtained from a construction equipment panel, data acquired using a robotic process automation (RPA), or data inputted to an existing platform connecting a construction production process or the dedicated application, for example.

Each of the constructor 101, the construction equipment information provider 102, and the oil provider 103 can operate a corresponding one of the constructor terminal 2, the construction equipment information provider terminal 3, and the oil provider terminal 4, thereby entering into a predetermined agreement with the service provider. The “predetermined agreement” described herein includes, for example, an agreement that the service provider or the construction company permits data acquisition for each type of construction equipment from each of the construction equipment information provider 102 and the oil provider 103 and sharing of such data among users and affiliates and an agreement that the service provider permits acquisition of comprehensive data from the construction equipment information provider 102 and utilization of such data. With this configuration, the number of construction equipment that can be managed can be increased without data acquired from the construction field. Each of the constructor 101, the construction equipment information provider 102, and the oil provider 103 enters into the predetermined agreement with the service provider so that the present service can be utilized. In addition, information regarding the owner and position of the construction equipment targeted for the present service is associated with each type of construction equipment.

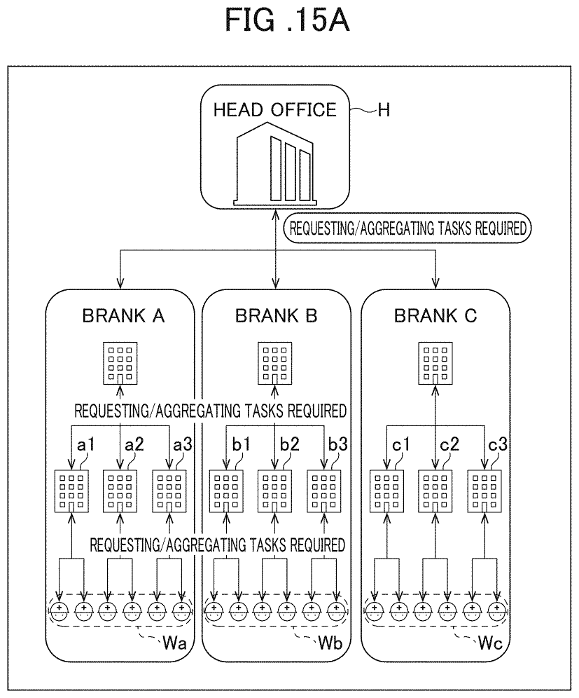

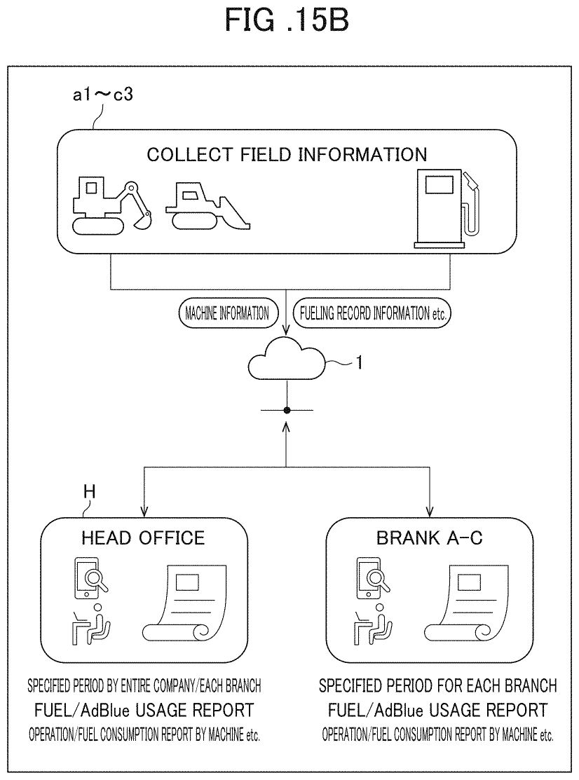

FIGS. 15A and 15B are image views showing that typical overlapping tasks are eliminated by applying the present service.

FIG. 15A shows a head office H of the constructor 101, branches A to C under the control of the head office H, construction fields a1 to a3 under the control of the branch A, construction fields b1 to b3 under the control of the branch B, construction fields c1 to c3 under the control of the branch C, and representatives Wa to Wc under the control of the construction fields a1 to a3, the construction fields b1 to b3, and the construction fields c1 to c3. In the typical constructor 101, a requesting task and an aggregating task are, for a single case, required for each of the branches A to C from the head office H. Moreover, a requesting task and an aggregating task are required for each of the construction fields al to a3, the construction fields b1 to b3, and the construction fields c1 to c3 from a corresponding one of the branches A to C. Further, a requesting task and an aggregating task are required for each of the representatives Wa to Wc from a corresponding one of the construction fields a1 to a3, the construction fields b1 to b3, and the construction fields c1 to c3. That is, in the typical constructor 101, a so-called top-down chain of command is established, and as a result, three requesting tasks and three aggregating tasks are required for the single case.

On the other hand, FIG. 15B shows the image in a case where the constructor 101 utilizes the present service. That is, in the constructor 101 utilizing the present service, e.g., the construction machine information 112, the construction field information 113, field information, and transaction report information including information regarding the construction equipment and information regarding the fueling record are collected in each of the construction fields a1 to a3, the construction fields b1 to b3, and the construction fields c1 to c3.

Specifically, the construction field information 113 includes, for example, information regarding a construction field name, a construction field address, a construction work type, a client, a designer, a builder, the name of the oil provider 103, a construction equipment owner, the scheduled date of commencement of work, the scheduled date of completion of work, a land area, and a total floor area. The collected construction machine information 112 and the collected construction field information 113 are, via a cloud provided by the server 1, generated in various report forms, and are provided to the head office H of the constructor 101 and the branches A to C. Note that “various report forms” are not particularly limited, and a wide variety of reports are generated and provided. Specifically, a report regarding fuel and AdBlue usages for whole company or each branch in a predetermined period, a report regarding an operation status and a fuel consumption for each type of construction equipment, or a report regarding annual inspection for each type of construction equipment are generated and provided, for example. Of these reports, a report regarding a light oil usage for whole company or each branch in a predetermined period includes, for example, information regarding the duration of use of construction equipment, the name of each construction field where construction equipment is located, the type (model) of construction equipment, and the light oil usage of construction equipment. That is, in the constructor 101 utilizing the present service, the aggregating task is automatically executed without the individual requesting tasks, and therefore, various reports as described above are generated and provided. Moreover, the constructor 101 can also easily output a basis for duty exemption application, for example. With this configuration, the task efficiency of the constructor 101 can be optimized.

In the present service, roles in each of the constructor 101, the construction equipment information provider 102, and the oil provider 103 are separately managed by the head office, the manager, and the representative. Specifically, in, e.g., the constructor 101, the head office performs aggregation across the entire company, the manager manages construction fields in a branch office, and a chief in a construction field is a representative operating the constructor terminal 2. For example, in the construction equipment information provider 102, the head office performs aggregation across the entire company, the manager manages equipment in a branch office, and a representative in a construction field is a representative managing equipment in each field. For example, in the oil provider 103, the head office performs aggregation across the entire company, the manager builds a transport route, and a construction equipment operator is a representative operating the constructor terminal 2.

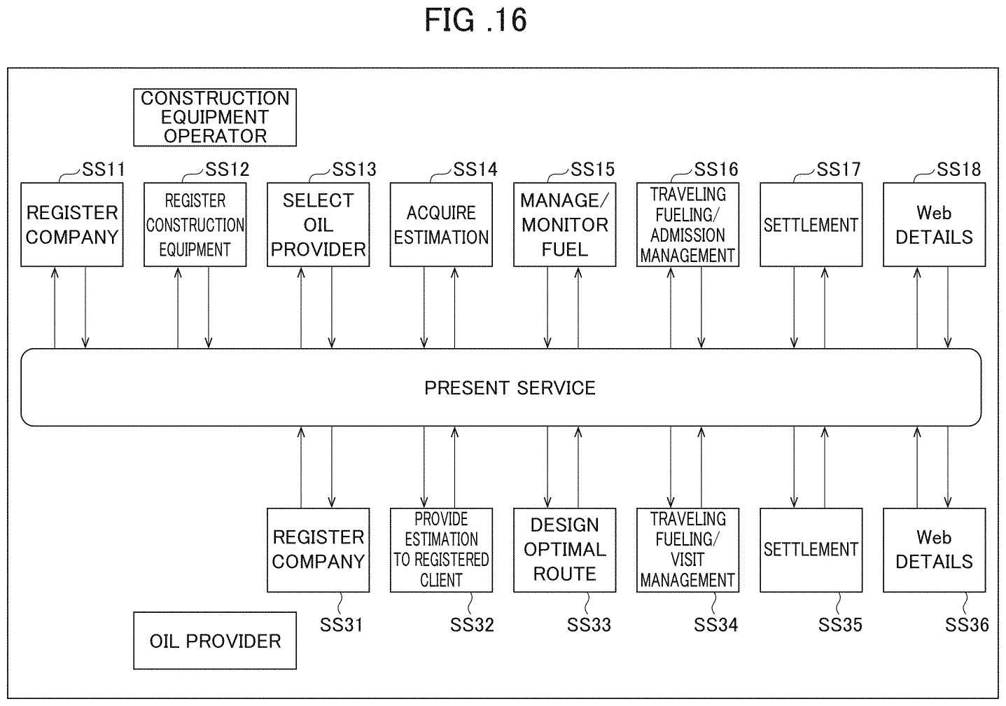

FIG. 16 is a flowchart showing one example of a relationship between the constructor and the oil provider receiving the present service. Note that the number of each step described below merely indicates one example of the order, and the order may be changed in some cases. Moreover, some steps may be omitted. Further, information or data exchanged at each step is not limited to contents described below.

At a step SS11, the representative of the constructor 101 operates the constructor terminal 2 to perform registration to the present service. Information inputted to the constructor terminal 2 is stored and managed in the integrated DB 51. At a step SS12, the representative of the constructor 101 operates the constructor terminal 2 to register the construction equipment. At a step SS31, the oil provider 103 operates the oil provider terminal 4 to input predetermined information, thereby performing registration to the present service. Information inputted to the oil provider terminal 4 is stored and managed in the integrated DB 51. At a step SS13, the constructor 101 operates the constructor terminal 2 to select the oil provider 103. Information necessary for selecting the oil provider 103 is stored in the integrated DB 51, and is provided from the present service to the constructor terminal 2. At a step SS14, the constructor 101 operates the constructor terminal 2 to provide the constructor information necessary for an estimation, thereby requesting the estimation for one or more oil providers 103. At a step SS32, the oil provider 103 operates the oil provider terminal 4 to input predetermined information, thereby referring to a customer introduced from the present service. Specifically, the oil provider 103 acquires, via the present service, information regarding the constructor 101 having requested the estimation, and produces and provides the estimation. When the constructor 101 agrees with the contents of the estimation, an agreement regarding fueling is concluded between the constructor 101 and the oil provider 103. At a step SS15, the constructor 101 starts providing data regarding fuel for each type of construction equipment. Accordingly, management and monitoring of the fuel for each type of construction equipment are started. At a step SS33, the oil provider 103 receives field information and the data regarding the fuel for each type of construction equipment via the present service, and based on such information, designs an optimal delivery route. Moreover, the oil provider 103 provides the present service with information regarding the position of a fueling vehicle on the delivery route. The present service provides, based on the information regarding the position of the fueling vehicle on the delivery route, information regarding the arrival time of the fueling vehicle at a construction field. At a step SS34, the oil provider 103 receives the AdBlue via the present service, and fuels the construction equipment present in the construction fields on the delivery route by means of the fueling vehicle. In this manner, the oil provider 103 visits and manages the construction fields. Moreover, the oil provider 103 provides the present service with data regarding fueling. At a step SS16, the constructor 101 receives fueling from the fueling vehicle and receives information indicating a fueling record via the present service while performing admission management. At a step SS17, the constructor 101 performs payment settlement transaction. Specifically, the constructor 101 requests the present service to perform the settlement transaction on behalf of the constructor 101. At a step SS35, the oil provider 103 performs sales settlement transaction. Specifically, the oil provider 103 performs the sales settlement transaction via the present service. At a step SS18, the constructor 101 acquires receipt data. Details of payment by the constructor 101 can be checked via a webpage. At a step SS36, the oil provider 103 provides the present service with data regarding the fueling record. Details of sales of the oil provider 103 can be checked via a webpage.

One embodiment of the present invention has been described above, but the present invention is not limited to the above-described embodiment. The present invention includes variations, modifications, etc. made within a scope that an object of the present invention can be achieved.

Although details have not been described above in the embodiment, credit and settlement functions associated with various functions such as “FUEL ESTIMATION REQUEST/CONFIRMATION”, “ESTIMATION CONFIRMATION”, and “BILLING” will be described. That is, in various functions such as “FUEL ESTIMATION REQUEST/CONFIRMATION”, “ESTIMATION CONFIRMATION”, and “BILLING”, “digitalization and smartification” of a billing/expense-submission flow are performed, thereby optimizing the efficiency. Construction equipment data as non-financial data is taken into consideration of a typical credit scoring model, thereby aiming at a simpler settlement/financial service. Specifically, in the present service, the server 1 can utilize construction machine operation information as non-financial information for a future cash flow prediction, and together with financial statements (PL/BS/CS) provided so far and a present cash hoard, can take such information as a credit basis. In a typical environment, even in a situation where determination needs to be made based only on the financial statements (PL/BS/CS), environment where a party involved (e.g., the constructor) can easily take a risk is provided using non-financial information (e.g., the constructor information or construction equipment information provider information) in combination with a current financial situation obtained from current financial information. Note that these credit and settlement functions include the function of providing a usance, and also include a function interposed between buying and selling.

“FUEL ESTIMATION REQUEST/CONFIRMATION” will be also briefly supplementally described. The “FUEL ESTIMATION REQUEST/CONFIRMATION” function is the function of requesting the oil provider to produce the estimation when the constructor demands fueling from the oil provider, but a fuel price envisioning function accompanied by the present service can achieve the following functions, for example. That is, (1) on a displayed screen relating to the “FUEL ESTIMATION REQUEST/CONFIRMATION” function in the constructor terminal 2, information regarding a plurality of available oil providers may be displayed in the order (a recommended order) of matching to a plurality of desired conditions.

(2) For example, the representative of the constructor selects one or more oil providers from a plurality of displayed oil providers, and inputs such information to the constructor terminal 2.

(3) For example, the representative of the constructor inputs, via the constructor terminal 2, conditions (e.g., “automatic fueling” and “credit card payment”) regarding fueling to the selected oil provider.

(4) For example, the representative of the constructor selects a desired store of the selected oil provider, and requests the estimation. Note that the estimation for the store may be collectively requested for a plurality of stores. Such an estimation request may be, for example, an inquiry request.

(5) On the constructor terminal 2, the status of the request estimation is displayed. That is, in the fuel price envisioning function accompanied by the present system, e.g., fueling terms and conditions of the plurality of oil providers for the constructor and an offer price for the constructor from the plurality of oil providers can be provided as a visualization list to the constructor terminal 2.

For example, in the above-described embodiment, it has been described that the single constructor selects the single oil provider, but the present invention is not particularly limited to such a case. That is, a single constructor may select a plurality of oil providers. Further, a plurality of constructors may select a plurality of oil providers. In other words, the present service can achieve matching among a plurality of constructors and a plurality of oil providers.

For example, in the above-described embodiment, it has been described that the constructor is, for example, the construction company managing the construction equipment, but the present invention is not particularly limited to such a case. That is, the constructor may be one demanding fueling, such as a company/individual or a hospital using equipment using fuel, such as a power generator or an oil heater.

For example, in the above-described embodiment, the construction equipment information provider is the company owning/manufacturing the construction equipment. Specifically, the construction equipment information provider has been, for example, described as the rental company renting the construction equipment, the manufacturing company manufacturing the construction equipment, and the construction equipment information providing company providing the information regarding the construction equipment, but the present invention is not particularly limited to such a case. That is, it may only be required that the construction equipment information provider is the company renting, e.g., the machine requiring fueling, the manufacturing company manufacturing the construction equipment, or the company providing the information regarding the construction equipment.

For example, in the above-described embodiment, the oil provider has been described as, e.g., the oil providing company providing fuel to the construction equipment, but the present invention is not particularly limited to such a case, but the present invention is not particularly limited to such a case. That is, it may only be required that the oil provider refills, e.g., the machine requiring fueling with fuel.

For example, in the above-described embodiment, it has been described that the server 1 provides, e.g., various types of information and the result of the arithmetic processing to each of the constructor, the construction equipment information provider, and the oil provider. That is, the server 1 does not necessarily provide various types of information and the result of the arithmetic processing to all of the constructor, the construction equipment information provider, and the oil provider, and may provide various types of information and the result of the arithmetic processing only to some of these three companies.

Further, in the above-described embodiment, it has been described that the server 1 provides, as the webpage, various types of information and the result of the arithmetic processing to each of the constructor, the construction equipment information provider, and the oil provider, but the present invention is not particularly limited to such a case. That is, the server 1 may generate and output a report based on various types of information and the result of the arithmetic processing, for example.

For example, the constructor information, the construction equipment information provider information, and the oil provider information described in the above-described embodiment are merely examples, and the present invention is not particularly limited to these examples. That is, the server 1 may acquire any type of information as long as such information is information regarding, e.g., the constructor, the construction equipment information provider, and the oil provider. Specifically, the server 1 may acquire information regarding maintenance of the construction equipment, for example. In this case, the server 1 can provide the information to, e.g., the constructor, the construction equipment information provider, and the oil provider, considering various types of information acquired as described above.

For example, in the above-described embodiment (mainly FIG. 10), it has been described that the monthly table or graph of the predetermined daily construction equipment operation time and fuel consumption is employed as the example of the information provided to the constructor, but the present invention is not particularly limited to such a case. That is, the server 1 may provide, as annual information, the constructor with predetermined monthly construction equipment operation time and fuel consumption, for example. Further, the operation time and the fuel consumption are merely examples of the information provided to the constructor, and the server 1 may collect other types of information excluding the operation time and the fuel consumption to provide the constructor with such information as, e.g., a monthly document.

For example, the above-described series of processing can be executed by hardware, or can be executed by software. A single functional block may include hardware alone, may include software alone, or may include a combination thereof. In other words, the functional configuration of FIG. 4 is merely an example, and is not particularly limited. That is, it may only be required that the information processing system has the functions capable of executing the above-described series of processing as a whole, and the functional blocks to be used to implement these functions are not particularly limited to those of the example of FIG. 4. The location of the functional block is not particularly limited to that of FIG. 4, and may be an optional location. A single functional block may include hardware alone, may include software alone, or may include a combination thereof.

For example, in the case of executing the series of processing by software, a program forming such software is installed on, e.g., a computer from a network or a recording medium. The computer may be a computer incorporated into dedicated hardware. The computer may be a computer capable of executing various functions by installing various programs, such as a server, a smartphone, a personal computer, or various devices.

For example, the recording medium including the programs includes, for example, not only a not-shown removable medium distributed separately from a device body to provide programs to, e.g., the constructor, the construction equipment information provider, and the oil provider, but also a recording medium provided to a user with the recording medium being incorporated into a device body in advance.

Note that in the present specification, the steps of describing a program recorded in a recording medium include not only processing performed in a chronological order, but also processing not performed in a chronological order but executed in parallel or separately. In the present specification, the term “system” means an entire device including a plurality of devices, a plurality of sections, etc.

In other words, the information processing device to which the present invention is applied can take a wide variety of forms including the following configurations.

That is, the information processing device to which the present invention is applied is an information processing device (e.g., the server 1 of FIG. 2) for providing information to each of

a first information processing terminal (e.g., the constructor terminal 2 of FIG. 2) managed by a construction company,

a second information processing terminal (e.g., the construction equipment information provider terminal 3 of FIG. 2) managed by a construction equipment information providing company, and

a third information processing terminal (e.g., the oil provider terminal 4 of FIG. 2) managed by an oil providing company.

It may only be required that the information processing device includes

a constructor information acquisition section (e.g., the constructor information acquisition unit 31 of FIG. 4) that acquires, as constructor information, various types of information regarding the construction company from the first information processing terminal,

a construction equipment information provider information acquisition section (e.g., the construction equipment information provider information acquisition unit 32 of FIG. 4) that acquires, as construction equipment information provider information, various types of information regarding the construction equipment information providing company from the second information processing terminal,

an oil provider information acquisition section (e.g., the oil provider information acquisition unit 33 of FIG. 4) that acquires, as oil provider information, various types of information regarding the oil providing company from the third information processing terminal, and

a providing section (e.g., the WEB screen generation unit 35 of FIG. 4) that generates suitable information to be provided to each of the construction company, the construction equipment information providing company, and the oil providing company based on the constructor information, the construction equipment information provider information, and the oil provider information and provides the suitable information to the construction company, the construction equipment information providing company, and the oil providing company.

For each of the construction company, the construction equipment information providing company, and the oil providing company, the service provider can thereby provide more appropriate information to each of the construction company, the construction equipment information providing company, and the oil providing company.

The constructor information may include information regarding a field where the construction company engages in a work,

the construction equipment information provider information may include information regarding construction equipment managed by the construction equipment information providing company, and

the oil provider information may include information regarding fuel.

For each of the construction company, the construction equipment information providing company, and the oil providing company, the service provider can thereby more appropriately provide information regarding, e.g., fueling of construction equipment to each of the construction company, the construction equipment information providing company, and the oil providing company.

The providing section can generate, as the suitable information to be provided to the oil providing company, information indicating a delivery route of a fueling vehicle of the oil provider for providing fuel one or more types of construction equipment managed by the construction company, and can provide such information to the oil provider. With this configuration, fueling of construction equipment in a plurality of locations can be efficiently performed.

The providing section can generate, as the information indicating the delivery route, an image displayed in a form of a webpage or an application, and can provide the image to the oil providing company. With this configuration, the delivery route for efficient fueling of the construction equipment in the plurality of locations can be grasped at first glance.

### EXPLANATION OF REFERENCE NUMERALS

1 Server

2 Constructor Terminal

3 Construction Equipment Information Provider Terminal

4 Oil Provider Terminal

5 Manager Terminal

6 Learning Device

11 CPU

12 ROM

13 RAM

14 Bus

15 Input/Output Interface

16 Output Unit

17 Input Unit

18 Storage Unit

19 Communication Unit

20 Drive

21 Removable Medium

31 Constructor Information Acquisition Unit

32 Construction Equipment Information Provider Information Acquisition Unit

33 Oil Provider Information Acquisition Unit

34 Arithmetic Unit

35 WEB Screen Generation Unit

36 Information Providing Unit

37 Learning Result Acquisition Unit

51 Integrated DB

71 Constructor WEB Unit

72 Construction Equipment Information Provider WEB Unit

73 Oil Provider WEB Unit

T Tank Truck

S Station

R Delivery Route

B Button

a to c Construction Field

Wa to We Representative

H Head Office

SS Each Step

1. An information processing device for providing information to each of
a first information processing terminal managed by a construction company,
a second information processing terminal managed by a construction equipment information providing company, and
a third information processing terminal managed by an oil providing company, comprising:
a constructor information acquisition section that acquires, as constructor information, various types of information regarding the construction company from the first information processing terminal;
a construction equipment information provider information acquisition section that acquires, as construction equipment information provider information, various types of information regarding the construction equipment information providing company from the second information processing terminal;
an oil provider information acquisition section that acquires, as oil provider information, various types of information regarding the oil providing company from the third information processing terminal; and
a providing section that generates suitable information to be provided to each of the construction company, the construction equipment information providing company, and the oil providing company based on the constructor information, the construction equipment information provider information, and the oil provider information and provides the suitable information to the construction company, the construction equipment information providing company, and the oil providing company.

2. The information processing device according to claim 1, wherein
the constructor information includes information regarding a field where the construction company engages in a work,
the construction equipment information provider information includes information regarding construction equipment managed by the construction equipment information providing company, and
the oil provider information includes information regarding fuel.

3. The information processing device according to claim 1, wherein
the providing section generates, as the suitable information to be provided to the oil providing company, information indicating a delivery route of a fueling vehicle of the oil provider for providing fuel one or more types of construction equipment managed by the construction company and provides the information to the oil provider.

4. The information processing device according to claim 3, wherein
the providing section generates, as the information indicating the delivery route, an image displayed in a form of a webpage or an application, and provides the image to the oil providing company.

5. A non-transitory computer readable medium storing a program for an information processing device for providing information to each of
a first information processing terminal managed by a construction company,
a second information processing terminal managed by a construction equipment information providing company, and
a third information processing terminal managed by an oil providing company, the program causing a computer to execute control processing including
a constructor information acquisition step of acquiring, as constructor information, various types of information regarding the construction company from the first information processing terminal,
a construction equipment information provider information acquisition step of acquiring, as construction equipment information provider information, various types of information regarding the construction equipment information providing company from the second information processing terminal,
an oil provider information acquisition step of acquiring, as oil provider information, various types of information regarding the oil providing company from the third information processing terminal, and
a providing step of generating suitable information to be provided to each of the construction company, the construction equipment information providing company, and the oil providing company based on the constructor information, the construction equipment information provider information, and the oil provider information and providing the suitable information to the construction company, the construction equipment information providing company, and the oil providing company.
